(19) United States
(12) Patent Application Publication
(10) Pub. No.: US 2009/0006322 A1
(43) Pub. Date: Jan. 1, 2009

(54) Method for Handling Web Search Results to Be Displayed on a Browser

(76) Inventors: Shannon H. Chang, Vail, AZ (US); Khanh V. Ngo, Tucson, AZ (US)

Correspondence Address: DILLON & YUDELL, LLP, 8911 N CAPITAL OF TEXAS HWY, SUITE 2110, AUSTIN, TX, 78759, US

(21) Appl. No.: 11/769,181

(22) Filed: Jun. 27, 2007

(51) Int. Cl. G06F 17/30

(52) U.S. Cl. 707/3; 707/E17.108

(57) ABSTRACT

A method for handling web search results to be displayed on a browser is disclosed. A history information file is initially provided on a search server connected to a network. The history information file includes a set of previously viewed websites. After the receipt of a search request from an internet browser on a computer connected to the network, an internet search is preformed according to a search criteria of the search request. After the previously viewed websites listed on the history information file have been removed from the current internet search results, the current search results are then sent to the internet browser to be displayed on the internet browser.

### BACKGROUND OF THE INVENTION

1. Technical Field

The present invention relates to web searching in general, and more particularly, to a method for displaying web search results. Still more particularly, the present invention relates to a method for handling web search results to be displayed on a browser.

2. Description of Related Art

Internet search engines, such as Google®, typically return numerous search results after a user has performed a web search on the Internet using a search criteria. The search results are usually displayed in the form of links to corresponding websites. A user may view any of the websites by clicking on its link. When the user returns to the search results page, the links of previously viewed websites are displayed in a different color from that of the links of unviewed websites.

The ability to utilize color to differentiate between the links of previously viewed websites and the links of unviewed websites on a search results page is usually limited by the cache memory (and/or history) size of a browser. A browser with a small cache memory may not be able to determine whether or not a link of a website has been previously viewed after a user has viewed a large number of websites within a search results page. Color-blind users may also experience difficulty in discerning between the two colors that correspond to links of previously viewed websites and unviewed websites listed on a search results page. Furthermore, when a user utilizes a different computer and/or browser to perform a second web search using the same search criteria as the first web search, the different computer and/or browser is incapable of displaying the links of any website previously viewed during the first web search session in a different color.

Consequently, it would be desirable to provide an improved method for displaying web search results.

### SUMMARY OF THE INVENTION

In accordance with a preferred embodiment of the present invention, a history information file is initially provided on a search server connected to a network. The history information file includes a set of previously viewed websites. After the receipt of a search request from an internet browser on a computer connected to the network, an internet search is preformed according to a search criteria of the search request. After the previously viewed websites listed on the history information file have been removed from the current internet search results, the current search results are then sent to the internet browser to be displayed on the internet browser.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of a computer network in which a preferred embodiment of the present invention is incorporated;

FIG. 2 is a block diagram of a history information file within the search server from FIG. 1, in accordance with a preferred embodiment of the present invention; and

FIG. 3 is a high-level logical flow diagram of a method for displaying web search results, in accordance with a preferred embodiment of the present invention.

### DETAILED DESCRIPTION OF A PREFERRED EMBODIMENT

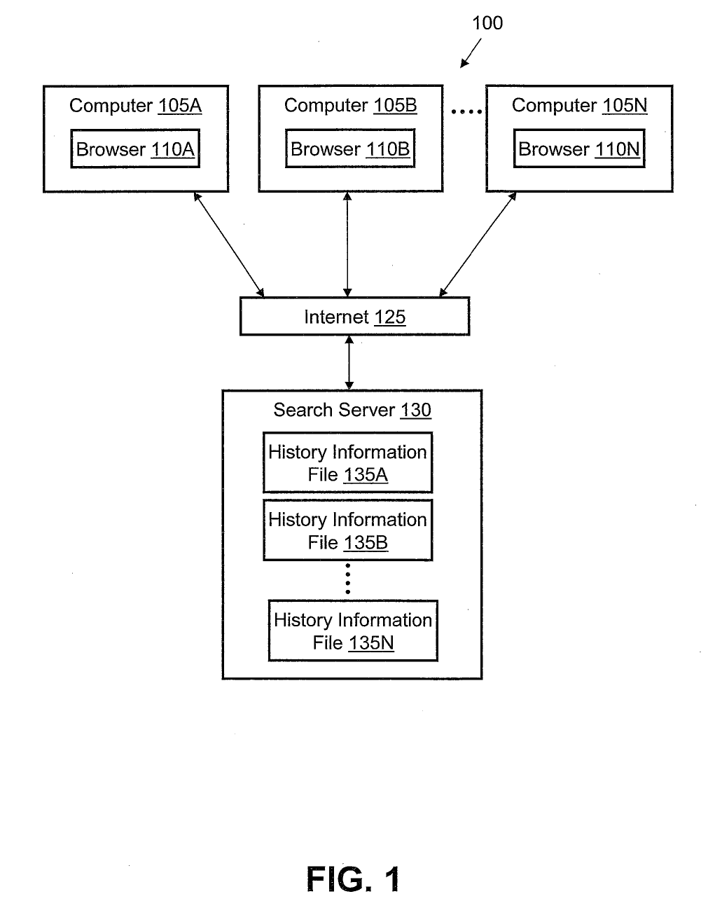

With reference now to the drawings, and in particular to FIG. 1, there is depicted a block diagram of a computer network in which a preferred embodiment of the present invention is incorporated. As shown, a computer network 100 includes computers 105A through 105N connected to a search server 130 via Internet 125. Computer 105A includes a browser 110A, computer 105B includes a browser 110B, and computer 105N includes a browser 110N. A user may perform internet searches using any one of computers 105A-105N.

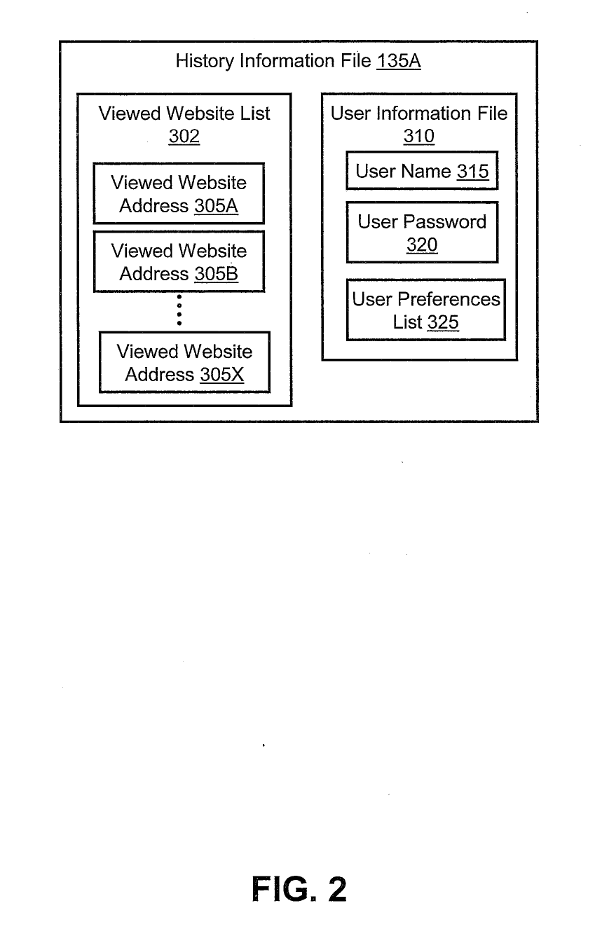

Search server 130 includes history information files 135A-135N, each associates with one or more users of computers 105A-105N. As utilized herein, a history information file refers to a data file that includes information corresponding to websites previously viewed by a user. A history information file may also contain specific user preferences, such as particular websites that a user does not want to be included in future search results and/or previously viewed websites that the user still wants to be included in future search results. After performing one or more internet searches on one of computers 105A-105N, a user may log on to search server 130 to edit the contents of the history information file corresponding to the user. Similarly, a user may log on to search server 130 to clear the history information file corresponding to the user. The process by which search server 130 provides personalized web search results to each user is illustrated in FIG. 2.

Since history information files 135A-135N are substantially identical with each other, only history information files 135A is described in details. Referring now to FIG. 2, there is illustrated a block diagram of a history information file within search server 135A, in accordance with a preferred embodiment of the present invention. As shown, history information file 135A includes a viewed website list 302 and a user information file 310. User information file 310 includes a user name 315 that corresponds to the user of history information file 135A, a user password 320 and a user preferences list 325. Viewed website list 302 includes viewed website addresses 305A-305X, each of which corresponds to a website that has been viewed by the user of history information file 135A. Preferably, any websites listed in viewed website list 302, such as viewed website addresses 305A-305X, will not be displayed on a search result page. However, if a user wishes to view a previously viewed website, the user may delete that particular previously viewed website from viewed website list 302.

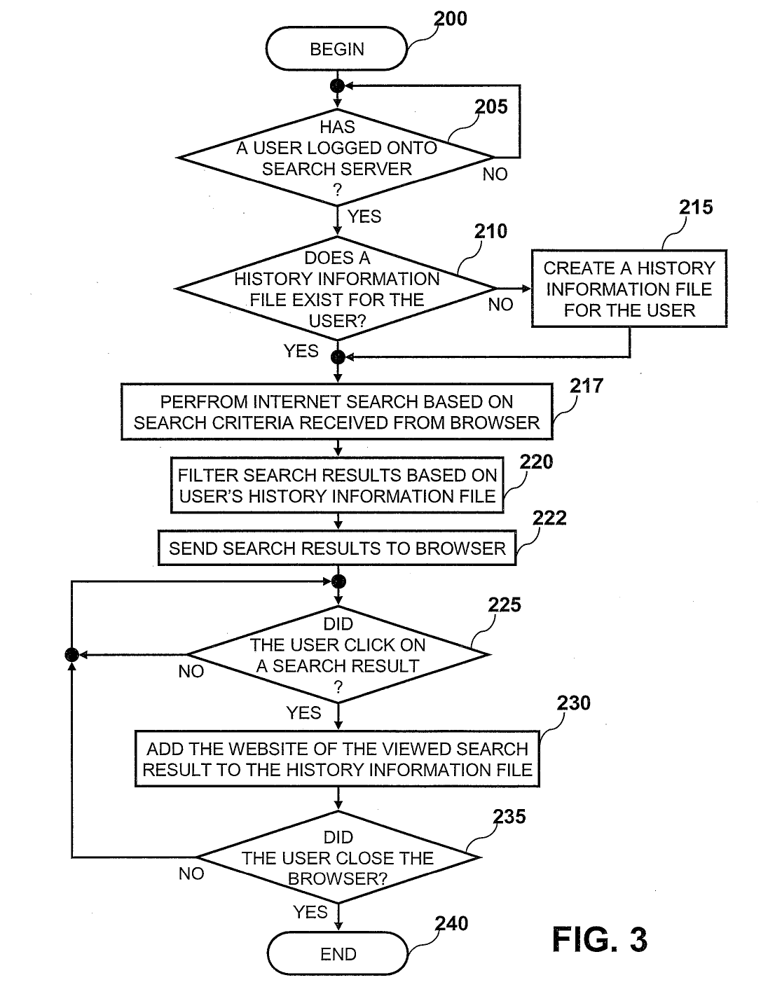

Referring now to FIG. 3, there is illustrated a high-level logic flow diagram of a method for displaying web search results, in accordance with a preferred embodiment of the present invention. Starting at block 200, a determination is made whether or not a user has successfully logged onto search server 130 (from FIG. 1), as depicted in block 205. If a user has not successfully logged onto search server 130, the process returns to block 205. Once a user successfully has logged onto search server 130, another determination is made whether or not search server 130 contains a history information file that corresponds to the user, as shown in block 210. If search server 130 does not contain a history information file that corresponds to the user, search server 130 then creates a history information file for the user, as shown in block 215.

Otherwise, if search server 130 contains a history information file that corresponds to the user, search server 130 then performs an internet search based on user-defined search criteria received from the browser of the user's computer, as depicted in block 217. Search server 130 accesses the history information file of the user and automatically removes all websites included in the user's history information file from the internet search results, as shown in block 220. The internet search results are then sent to the user's browser to be displayed on the user's browser, as shown in block 222.

Search server 130 determines whether or not the user has viewed a website on the internet search results displayed within the browser of the user's computer (usually by “clicking” on a link via a pointing device), as shown in block 225. If the user has not viewed a website on the internet search result, the process returns to block 225. However, if the user has viewed a website on the internet search result, search server 130 adds the viewed website to a viewed website list, such as viewed website list 302 from FIG. 2, in the user's history information file, as shown in block 230.

A determination is made whether or not the user has closed the browser (i.e., whether or not the search session has concluded), as depicted in block 235. If the user has not closed the browser, the process returns to block 225. Otherwise, if the user has closed the browser, the process terminates at block 240.

As has been described, the present invention provides an improved method for displaying web search results.

While an illustrative embodiment of the present invention has been described in the context of a fully functional computer system, those skilled in the art will appreciate that the software aspects of an illustrative embodiment of the present invention are capable of being distributed as a program product in a variety of forms, and that an illustrative embodiment of the present invention applies equally regardless of the particular type of media used to actually carry out the distribution. Examples of the types of media include recordable type media such as thumb drives, floppy disks, hard drives, CD ROMs, DVDs, and transmission type media such as digital and analog communication links.

While the invention has been particularly shown and described with reference to a preferred embodiment, it will be understood by those skilled in the art that various changes in form and detail may be made therein without departing from the spirit and scope of the invention.

What is claimed is:

1. A method for handling web search results to be displayed on a browser, said method comprising:
providing a history information file on a search server connected to a network, wherein said history information file includes a plurality of previously viewed websites;
performing an internet search according to a search criteria received from an internet browser on a computer connected to said network; and
sending current search results to said internet browser to be displayed on said internet browser after said plurality of previously viewed websites had been removed from said current internet search results.

2. The method of claim 1, wherein said history information file further includes a user information file having a user name, a user password and a user preference list.

3. The method of claim 1, wherein said history information file stores said plurality of previously viewed websites in the form of corresponding internet addresses.

4. The method of claim 1, wherein said method farther includes adding a new previously viewed website to said history information file after a website listed on said current search results has been viewed via said internet browser.

5. A computer storage medium having a computer program product for handling web search results to be displayed on a browser, said computer storage medium comprising:
computer program code for providing a history information file on a search server connected to a network, wherein said history information file includes a plurality of internet addresses corresponding to previously viewed websites;
computer program code for performing an internet search according to a search criteria received from an internet browser on a computer connected to said network; and
computer program code for sending current search results to said internet browser to be displayed on said internet browser after said plurality of previously viewed websites had been removed from said current internet search results.

6. The computer storage medium of claim 5, wherein said history information file farther includes a user information file having a user name, a user password and a user preference list.

7. The computer storage medium of claim 5, wherein said history information file stores said plurality of previously viewed websites in the form of corresponding internet addresses.

8. The computer storage medium of claim 5, wherein said computer storage medium further includes computer program code for adding a new previously viewed website to said history information file after a website listed on said current search results has been viewed via said internet browser.
